(19) United States
(12) Patent Application Publication
(10) Pub. No.: US 2005/0034492 A1
(43) Pub. Date: Feb. 17, 2005

(54) Padlock

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/916,510

(22) Filed: Aug. 12, 2004

Related U.S. Application Data
(63) Continuation-in-part of application No. 10/671,659, filed on Sep. 29, 2003.
(63) Continuation-in-part of application No. 10/676,853, filed on Sep. 30, 2003.

(30) Foreign Application Priority Data
Aug. 22, 2003 (TW) 92115338
Aug. 15, 2003 (TW) 92214875

(51) Int. Cl. E05B 37/02

(52) U.S. Cl. 70/25

(57) ABSTRACT

A padlock that can be operated without using both hands is provided. The padlock mainly contains: a lock body, a shackle, a restriction device and a locking means. The shackle has a base end and a free end. The base end is pivotally installed in a side of the lock body whereby the shackle can be freely rotated about the base end without axial movement. The restriction device has a restriction button and a driving element extended from a bottom of the restriction button. The restriction button is disposed on the lock body and is formed with a notch corresponding to the free end of the shackle for restricting the same. The driving element is movably installed in the lock body. The locking means is formed in the lock body for controlling movements of the driving element in order the notch of the restriction button to be engaged with or disengaged from the free end of the shackle, wherein the notch is formed at a top of the restriction button and is extended from a edge to a center of the restriction button.

This is a continuation-in-part application of the co-pending U.S. Ser. No. 10/671,659, application filed on Sep. 29, 2003, and also a continuation-in-part application of the co-pending U.S. Ser. No. 10/676,853, application filed on Sep. 30, 2003.

### TECHNICAL FIELD

This invention relates generally to a padlock, in particular, to provide a padlock having a restriction button formed with a notch for being engaged with a free end of a shackle thereof.

### BACKGROUND OF THE INVENTION

A conventional padlock contains a lock body, a shackle and a key operated locking means. The shackle has a based end installed in one side of the lock body and a free end. The lock body has concave at the other side thereof. The key operated locking means is for controlling vertical movement of the base end so that the free end of the shackle is engaged with or disengaged from the concave. When the free end of the shackle is engaged with the concave of the lock body, the padlock is locked while when the free end of the shackle is disengaged from the concave of the lock body, the padlock is unlocked.

Another conventional padlock contains a lock body, a shackle and a combination locking means. The shackle has a based end installed in one side of the lock body and a free end. The lock body has concave at the other side thereof. The combination locking means contains plural number wheels and is for controlling vertical movement of the base end so that the free end of the shackle is engaged with or disengaged from the concave. When the free end of the shackle is engaged with the concave of the lock body, the padlock is locked while when the free end of the shackle is disengaged from the concave of the lock body, the padlock is unlocked.

In each of the above mentioned conventional padlocks, a user have to hold the lock body with one hand and push down the shackle to lock the padlock with another hand. It's inconvenient for a one hand person or somebody is busy at the other hand to operate this kind of padlock. Therefore a padlock that can be operated without using both hands is needed.

### SUMMARY OF INVENTION

It is therefore an objective of the present invention to provide a padlock that can be operated without using both hands.

The present invention, briefly summarized, in one embodiment discloses a padlock. The padlock mainly contains: a lock body, a shackle, a restriction device and a locking means. The shackle has a base end and a free end. The base end is pivotally installed in a side of the lock body whereby the shackle can be freely rotated about the base end without axial movement. The restriction device has a restriction button and a driving element extended from a bottom of the restriction button. The restriction button is disposed on the lock body and is formed with a notch corresponding to the free end of the shackle for restricting the same. The driving element is movably installed in the lock body. The locking means is formed in the lock body for controlling movements of the driving element in order the notch of the restriction button to be engaged with or disengaged from the free end of the shackle wherein the notch is formed at a top of the restriction button and is extended from a edge to a center of the restriction button.

### BRIEF DESCRIPTION OF DRAWINGS

The invention will be more clearly understood after referring to the following detailed description read in conjunction with the drawings wherein:

FIG. 1 is a perspective exploded view of a first embodiment of present invention;

FIG. 2 is a perspective assembled view of the first embodiment;

FIG. 3 is a cross sectional view of the locked first embodiment;

FIG. 3A is a top view according to FIG. 3;

FIG. 4 is a cross sectional view of the unlocked first embodiment;

FIG. 4A is a top view according to FIG. 4;

FIG. 5 is a perspective view of a second embodiment;

FIG. 6 is a cross sectional view of the second embodiment showing the shackle being locked;

FIG. 7 is an exploded view of the restriction device of the second embodiment;

FIG. 8 is a perspective view of the second embodiment showing the restriction button being rotated to a position for releasing the free end of the shackle;

FIG. 9 is a cross sectional view of the second embodiment showing the free end of the shackle being released from the notch of the restriction button;

FIG. 10 is a perspective view of a third embodiment;

FIG. 11 is a cross sectional view of the third embodiment showing the shackle being locked;

FIG. 12 is an exploded view of the key operated locking means and the restriction device of the third embodiment;

FIG. 13 is a cross sectional view of the third embodiment showing the free end of the shackle being released from the combination locking means;

FIG. 14 is a perspective view of the third embodiment showing the restriction button being rotated to a position for releasing the free end of the shackle;

FIG. 15 is a cross sectional view of the third embodiment showing the restriction button being rotated by the key and the free end of the shackle be removed from the notch;

FIG. 16 is a perspective view of the fourth embodiment;

FIG. 17 is a cross section al view of the fourth embodiment showing the shackle being locked and the protrusion of the restriction button being engaged with the hemi-cylinder for preventing the restriction button from rotation;

FIG. 18 is a perspective view of the fourth embodiment showing the restriction button being rotated to allow the free end of the shackle being released from the notch; and

FIG. 19 is a cross sectional view of the fourth embodiment showing the key rotates the hemi-cylinder to a position for allowing the restriction button being rotated to allow the free end of the shackle being released from the notch.

### DETAILED DESCRIPTION OF PREFERRED EMBODIMENTS

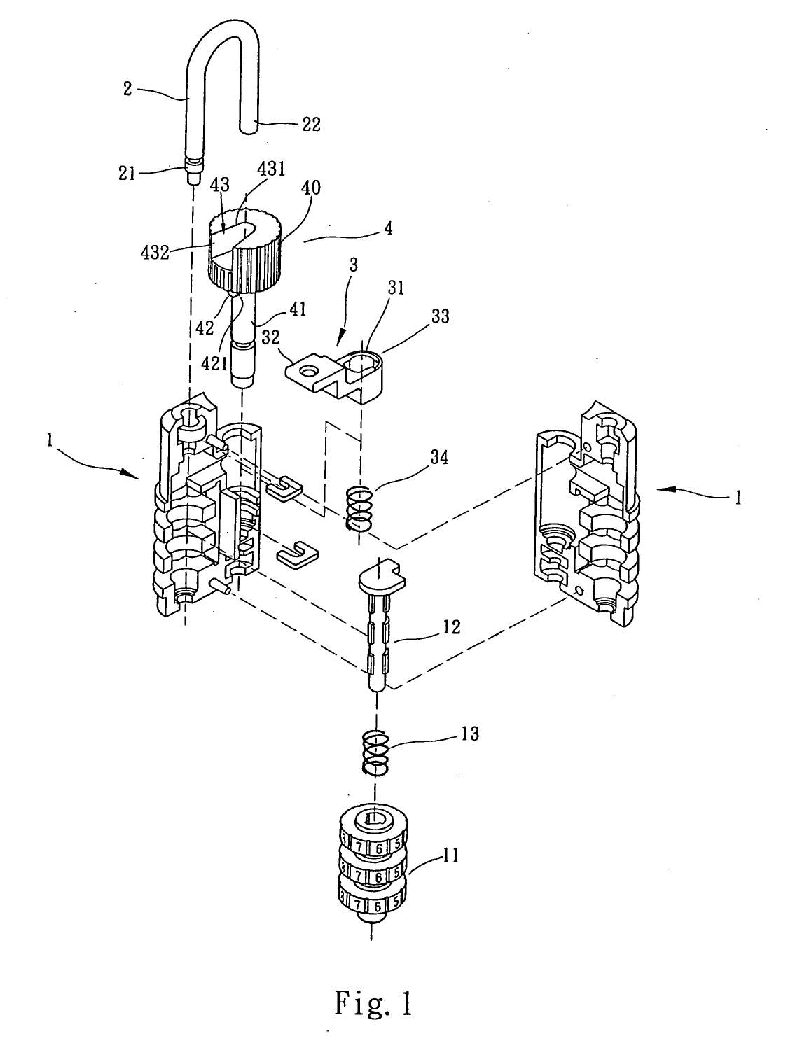

Please refer to FIG. 1, which shows a first embodiment of the present invention. The padlock includes a lock body 1, a shackle 2, a linking member 3 and a restriction device 4. A stem 12 is arranged in the lock body 1. Plural number wheels 11 rotatably mounted around the stem 12. When the number wheels 11 are dialed to the correct number, the stem 12 can be unlocked and moved. A resilient member 13 such as a spring is fitted on the stem 12. The resilient member 13 is compresses between the top end of the stem 12 and the number wheels 11, whereby in normal state, the lock is resiliently forced to abut against the linking member 3. The shackle 2 is substantially U-shaped and has a base end 21 and a free end 22. The base end 21 is pivotally installed in one side of the lock body 1, whereby the shackle 2 can be freely rotated about the base end 21. The linking member 3 is formed with a central through shaft hole 31. The circumference of top side of the shaft hole 31 is formed with a recession 33. Two sides of the recessed section 33 are respectively formed with two lateral recessed slopes 331 which upward obliquely extend. In addition, a plane like pressing section 32 extends from a lateral edge of the linking member 3 toward the stem 12.

The top end of the restriction device 4 is substantially a restriction button 40. The restriction button 40 is formed with a notch 43 tapered from one side to the center, whereby the notch 43 has a receptacle 431 at a center thereof and a gap 432 at an edge thereof and the receptacle 431 is communicated with the gap 432. A driving element 41 projects from lower end of the restriction button 40. An acute projecting section 42 corresponding to the recessed section 33 is formed at an adjoining section between the driving element 41 and the restriction button 40. Two sides of the acute projecting section 42 are formed with lateral projecting slopes 421 corresponding to the lateral recessed slopes 331.

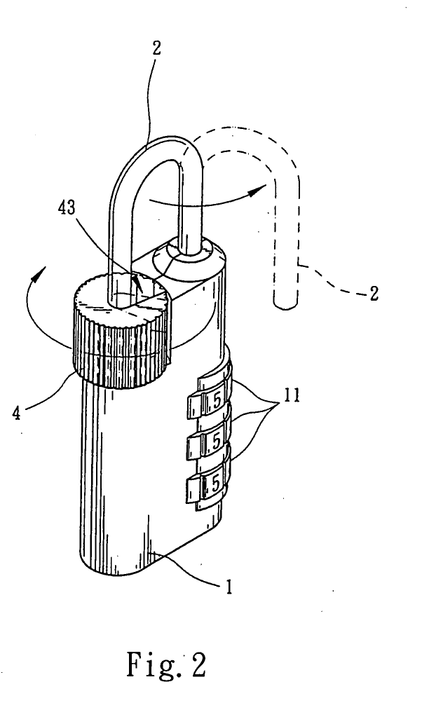

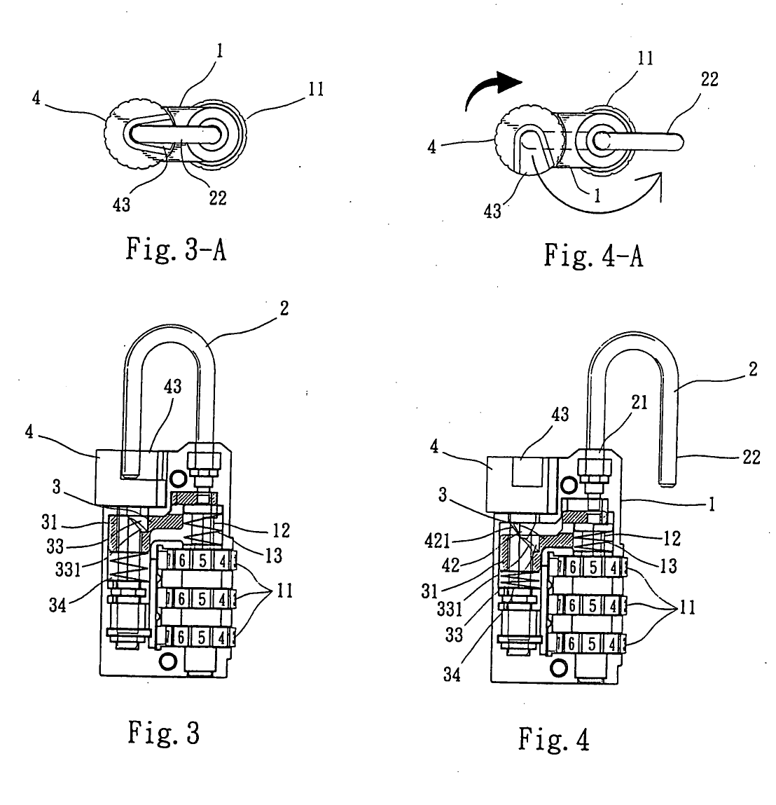

FIG. 2 is a perspective assembled view according to FIG. 1. Also with reference to FIGS. 3 and 3A, when assembled, the linking member 3 and the stem 12 are disposed in the lock body 1 on different sides thereof. The pressing section 32 of the linking member 3 extends to upper side of the stem 12 to press the same. The driving element 41 of the restriction device 4 is inserted in the lock body 1 and rotatably passed through the shaft hole 31 of the linking member 3. A resilient member 34 such as a spring is disposed between the linking member 3 and the inner side of the lock body 1 near the tail end of the driving element 41. The resilient member 34 makes the linking member 3 naturally attach to the end of the lock body 1 in which the restriction device 4 is installed. The acute projecting section 42 of the restriction device 4 is totally inlaid in the recess section 33 of the linking member 3. The notch 43 is kept in a closed position to restrict the movement of the free end 22 of the shackle 2. Accordingly when the number wheels 11 in the locking position, the stem 12 is engaged and cannot be pressed down. At this time, the stem 12 abuts against the linking member 3 to prevent the linking member 3 from descending. Therefore, the restriction device 4 is restricted from moving, that is the restriction device 4 cannot be turned so that free end 22 of the shackle 2 is still restricted by the restriction device 4 from rotating out.

FIGS. 4 and 4A show the unlocking operation of the first embodiment of the present invention. When the number wheels 11 are dialed to the unlocking number, the stem 12 is released from the engagement. At this point, the stem 12 can be pressed down. When rotating the restriction device 4, the acute projecting section 42 of the restriction device 4 downwardly slides along the laterally recessed slopes 331 of the recessed section 33 to press down the top side of the linking member 3. Accordingly, the bottom end of the linking member 3 compresses the resilient member 34 and moves downwardly. At this point, the pressing section 32 downwardly presses the stem 12 and the resilient member 13. After the restriction device 4 is rotated about 90 degrees, the notch 43 of the restriction device 4 is turned to a direction to free the free end 22 of the shackle 2, whereby the free end 22 of the shackle 2 can be rotated to an unlocking position and detached from the notch 43 of the restriction device 4.

In practicing the first embodiment, to put the free end 22 of the shackle 2 into the notch 43 of the restriction device 4, a user can hold the lock body 1 with his/her palm and turn the restriction device 4 with his/her index finger and thumb, then swing the free end 22 of the shackle 2 into the notch 43 of the restriction device 4 and thereafter release the restriction device 4. All this can be finished by one hand.

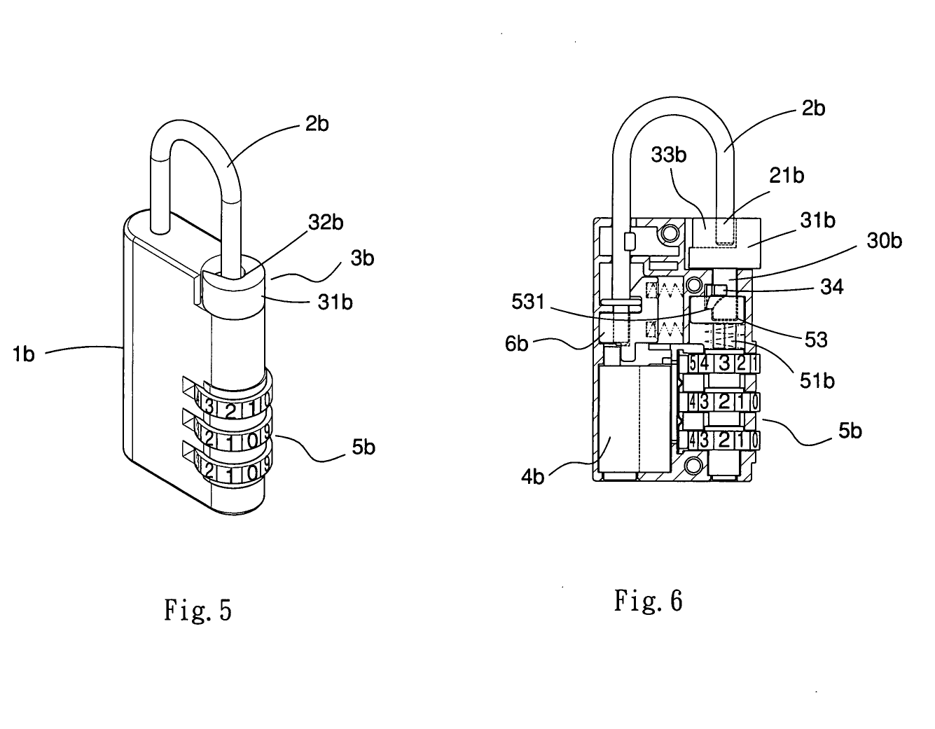

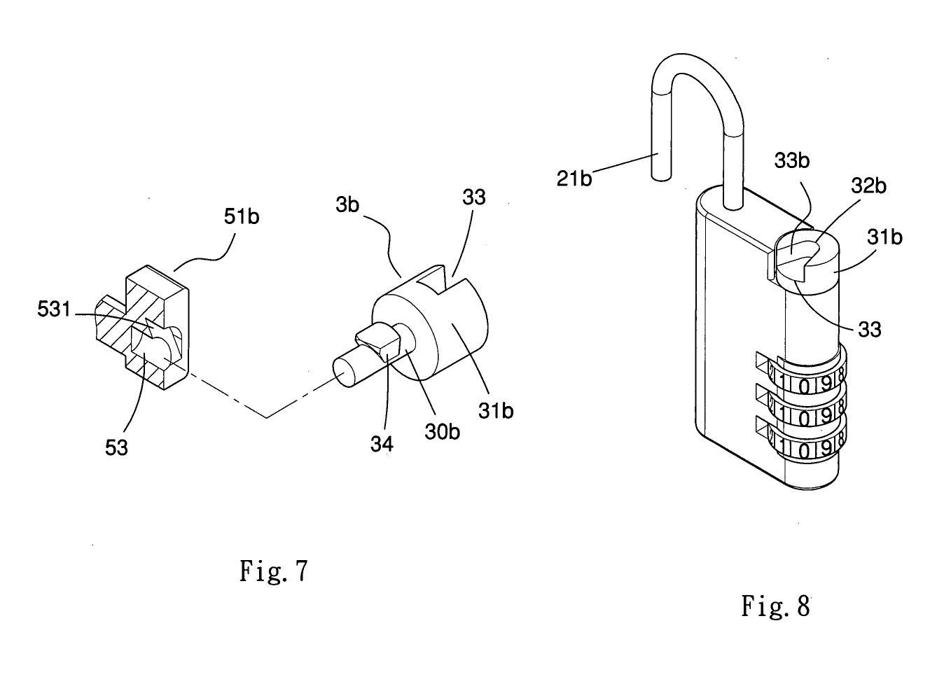

With reference to FIG. 5 to FIG. 9, the padlock of the second embodiment of the present invention contains a lock body 1b, a shackle 2b, a restriction device 3b, a key operated locking means 4b, a combination locking means 5b and a locking mechanism 6b. A stem 51b of the combination locking means 5b has a recess 53 at top thereof. The recess 53 has a concave 531 at a wall thereof. The restriction device 3b has a restriction button 31b and a driving element 30b. The restriction button 31b is disposed on the lock body 1b and formed with a notch 33b at a top of the restriction button 31b, corresponding to a free end 21b of the shackle 2b. The notch 33b has a gap 33 communicated with a receptacle 32b of the restriction button 31b. The gap 33 has a width larger than the diameter of the free end 21b of the shackle 2b for receiving the same. The driving element 30b extended from a bottom of the restriction button 31b has a protrusion 34 thereon for being engaged with the concave 531. The driving element 30b is received in the recess 53. After dialing the combination locking means 5b to an unlocking number, the gap 33 can be rotated to a position that the free end 21b of the shackle 2b can be removed therefrom.

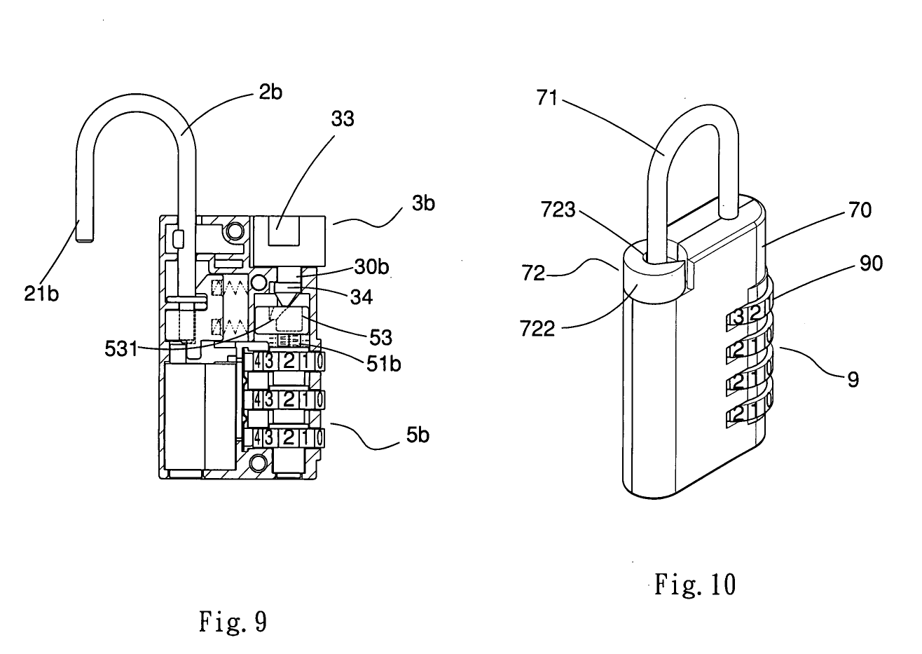

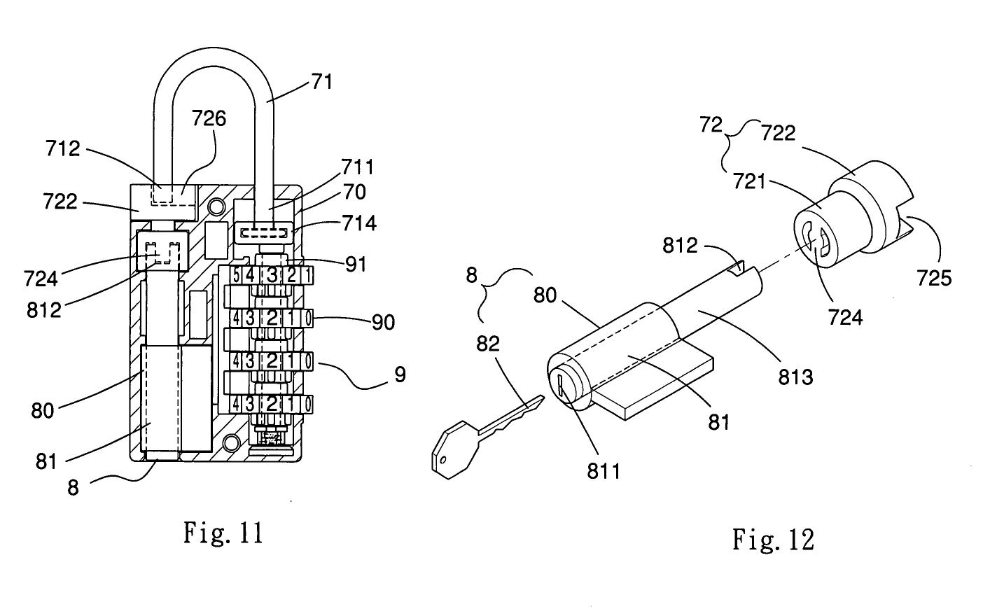

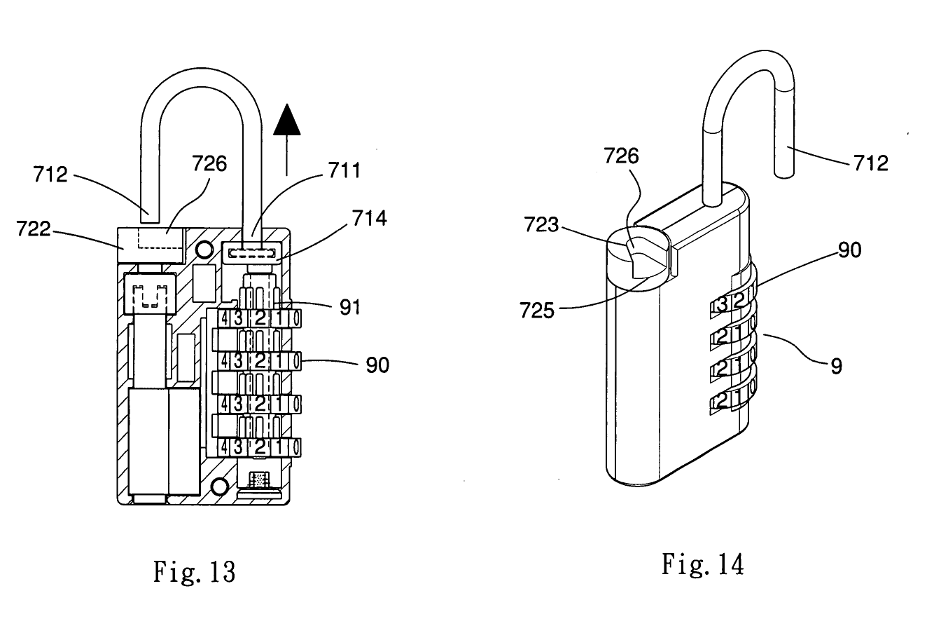

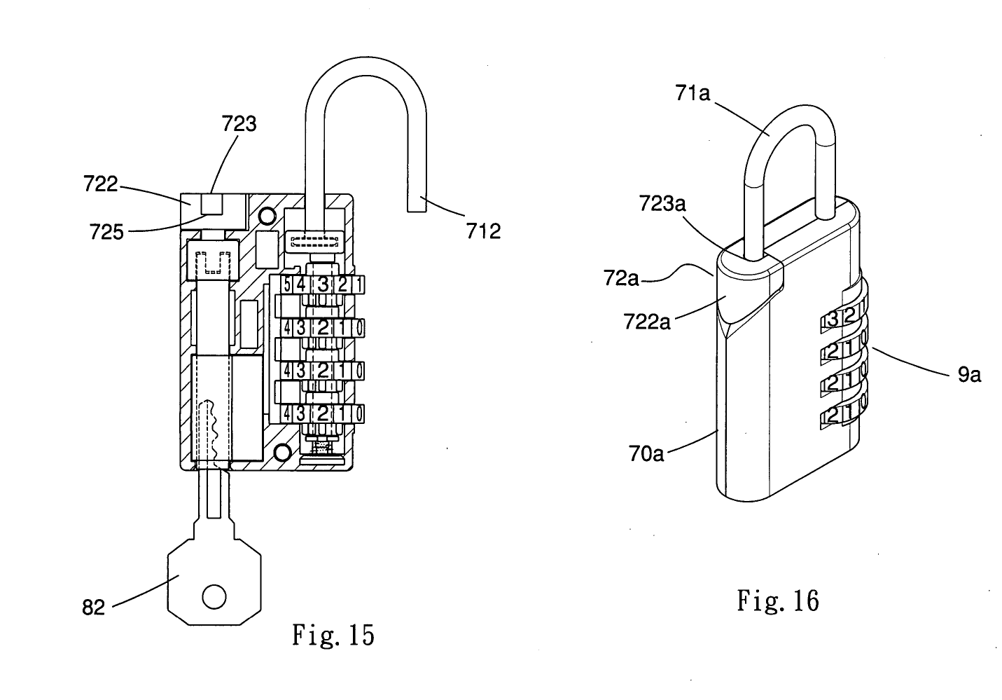

With reference to FIG. 10 to FIG. 15, the padlock of the third embodiment of the present invention mainly contains: a lock body 70, a restriction device 72, a shackle 71, a combination locking means 9 and a key operated locking means 8. The restriction device 72 has a restriction button 722 and a driving element 721. The restriction button 722 is disposed on the lock body 70 and formed with a notch 726. The notch 726 is formed at a top of the restriction button 722 and has a gap 725 communicated with a receptacle 723 of the restriction button 722. The gap 725 has a width larger than the diameter of the free end 712 for receiving the end of the free end 712. The shackle 71 has a base end 711 pivotally installed in the lock body 70 and a free end 712. The combination locking means 9 formed in the lock body 70 for locking or unlocking the base end 711 of the shackle 71. The key operated locking means 8 is formed in the lock body 70 for controlling movements of the restriction device 72 in order the restriction button 722 to be engaged with or disengaged from the free end 712 of the shackle 71.

The driving element 721 is extended from a bottom of the restriction button 722 and has one plate 724 therein. The key operated locking means 8 contains: a body 80 having a rotor 81 received therein and a driving rod 813 extended from the rotor 81. The rotor 81 has a keyhole 811 at a bottom end thereof for being engaged with a key 82. The driving rod 813 has a slot 812 at a top end thereof for being engaged with the plate 724. When the key 82 rotates the rotor 81, the driving rod 813 simultaneously rotates the driving element 721 and the gap 725 is rotated to a position so the free end 712 can be removed from the gap 725.

The base end 711 of the shackle 71 is connected with a lock mechanism 714. The combination locking means 9 contains a stem 91 and plural number wheels 90 rotatably mounted around the stem 91 for controlling movements of the stem 91. When the combination locking means 9 is dialed to an unlocking number, the stem 91 triggers the lock mechanism 714 and the base end 711 is biased upwardly thereby the free end 712 is removed from the notch 726. The gap 725 of the receptacle 723 is a radial gap having a smallest width at an inner periphery, wherein the smallest width of the radial gap is larger than the diameter of the free end 712 of the shackle 71.

With reference to FIG. 16 to FIG. 19, the padlock of the fourth embodiment of the present invention mainly contains: a lock body 70a, a shackle 71a, a restriction device 72a, a resilient member 724a such as a spring, a combination locking means 9a and a key operated locking means 8a. The restriction device 72a has a restriction button 722a and a driving element 721a. The restriction button 722a is disposed on the lock body 70a and has a notch 726a formed at a top of the restriction button 722a. The notch 726a has a receptacle 723a at a center thereof and a gap 725a at an edge thereof. The receptacle 723a is communicated with the gap 725a. The resilient member 724a is engaged with the restriction device 72a for restoring the restriction device 72a. The shackle 71a has a base end 711a pivotally installed in a side of the lock body 70a and a free end 712a engagable with the notch 723a of the restriction button 72a. The combination locking means 9a is formed in the lock body 70a for controlling axial movements of the base end 711a of the shackle 71a. The key operated locking means 8a is formed in the lock body 70a for controlling rotation of the restriction device 72a in order the restriction button 722a to be engaged with or disengaged from the free end 712a of the shackle 71a. The key operated locking means 8a contains a body 80a having a rotor 81a received therein and a driving rod 812a extended from the rotor 81a. The rotor 81a has a keyhole 83a at a bottom end thereof for being engaged with a key 82a. The driving rod 812a such as a hemi-cylinder is engaged with the driving element 721a of the restriction device 72a.

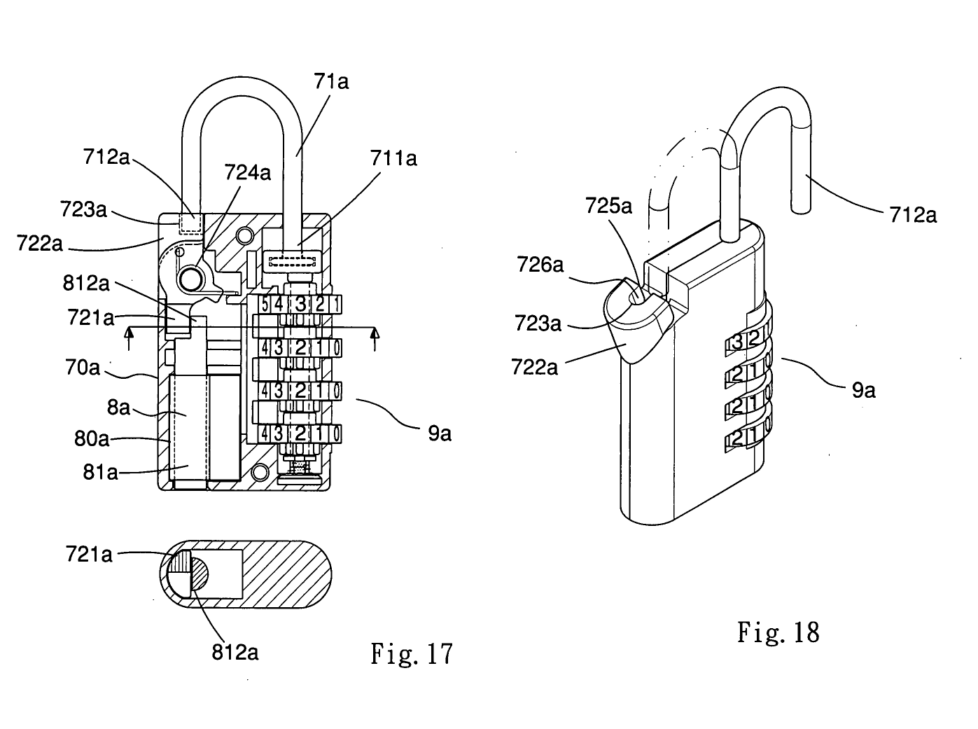

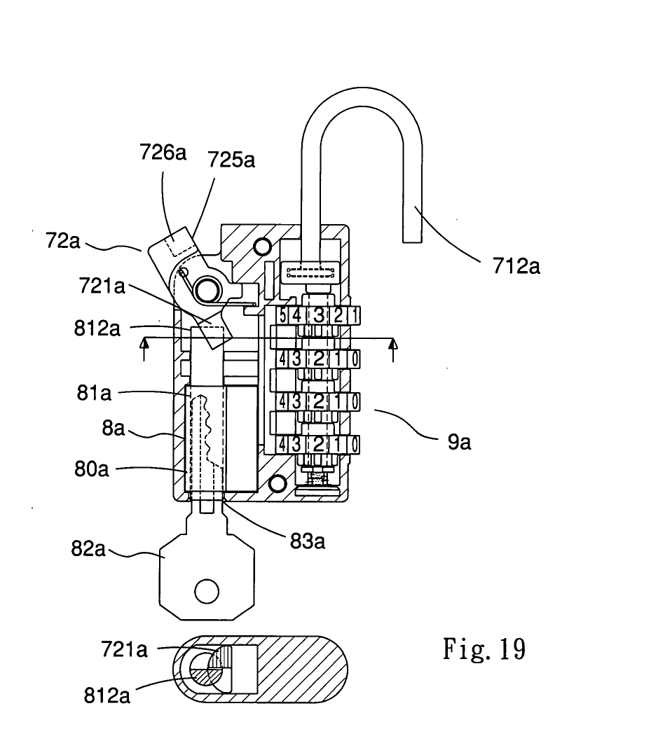

Referring to FIG. 17, the driving element 721a is engaged with the driving rod 812a. Thereby the restriction device 72a is prevented from rotation. Referring to FIG. 19, the key 82a rotates the rotor 81a which simultaneously rotates the driving rod 812a to a position; thereby the restriction button 72a can rotate to let the free end 712a removed from the notch 726a. The combination locking means 9a of the fourth embodiment is the same as the combination locking means 9 of the third embodiment.

Numerous characteristics and advantages of the invention have been set forth in the foregoing description, together with details of the structure and function of the invention, and the novel features thereof are pointed out in appended claims. The disclosure, however, is illustrated only, and changes may be made in detail, especially, in matters of shape, size and arrangement of parts, materials and the combination thereof within the principle of the invention, to the full extend indicated by the broad general meaning of the terms in which the appended claims are expressed.

1. A padlock comprising:
a lock body;
a shackle having a base end and a free end, said base end being pivotally installed in a side of said lock body, whereby said shackle can be freely rotated about said base end without axial movement;
a restriction device having a restriction button and a driving element extended from a bottom of said restriction button, said restriction button being disposed on said lock body and being formed with a notch corresponding to said free end of said shackle for restricting the same, said driving element being movably installed in said lock body; and
a locking means formed in said lock body for controlling movements of said driving element in order said notch of said restriction button to be engaged with or disengaged from said free end of said shackle;
wherein said notch is formed at a top of said restriction button and has a receptacle at a center thereof and a gap at an edge thereof, said receptacle being communicated with said gap.

2. The padlock of claim 1 wherein said locking means is a combination locking means comprising plural number wheels, and said driving element is movable when said plural number wheels are dialed to unlocking numbers.

3. The padlock of claim 1 wherein said locking means is a key operated locking means, and said driving element is movable when said key operated locking means is unlocked.

4. The padlock of claim 1 further comprising a resilient member for restoring said restriction button and said driving element.

5. The padlock of claim 3 wherein said key operated locking means comprises a body having a rotor received therein and a driving rod extended from said rotor, said rotor having a keyhole at a bottom end thereof for being engaged with a key, said driving rod is for controlling movements of said driving element.

6. The padlock of claim 4, wherein said locking means is a key operated locking means, and said driving element is movable when said key operated locking means is unlocked.

7. The padlock of claim 5, wherein said driving element having one plate, said driving rod having one slot at an end thereof for being engaged with said plate.

8. The padlock of claim 6, wherein said key operated locking means comprises a body having a rotor received therein and a driving rod extended from said rotor, said rotor having a keyhole at a bottom end thereof for being engaged with a key, said driving rod is for controlling movements of said driving element.

9. A padlock comprising:
a lock body;
a shackle having a base end and a free end, said base end being pivotally installed in a side of said lock body;
a restriction device having a restriction button and a driving element extended from a bottom of said restriction button, said restriction button being disposed on said lock body and being formed with a notch corresponding to said free end of said shackle for restricting the same, said driving element being movably installed in said lock body;
a first locking means formed in said lock body for controlling axial movements of said base end; and
a second locking means formed in said lock body for controlling movements of said driving element in order said notch of said restriction button to be engaged with or disengaged from said free end of said shackle;
wherein said notch is formed at a top of said restriction button and has a receptacle at a center thereof and a gap at an edge thereof, said receptacle being communicated with said gap.

10. The padlock of claim 9 wherein said first locking means is a combination locking means and said second locking means is a key operated locking means.

11. The padlock of claim 9 wherein said first locking means is a key operated locking means and said second locking means is a combination locking means.

12. The padlock of claim 9 wherein said first locking means comprises:
a locking mechanism; and
a combination locking means comprising a stem and plural number wheels for controlling movements of said stem;
wherein said stem triggers said locking mechanism for controlling movements of said base end of said shackle; and
wherein said second locking means comprises: a body having a rotor received therein and a driving rod extended from said rotor, said rotor having a keyhole at a bottom end thereof for being engaged with a key, said driving rod is for controlling movements of said driving element.

13. The padlock of claim 9 further comprising a resilient member for restoring said restriction button and said driving element.

14. The padlock of claim 12, wherein said driving element having one plate, said driving rod having one slot at an end thereof for being engaged with said plate.

15. The padlock of claim 13 wherein said first locking means comprises:.
a locking mechanism; and
a combination locking means comprising a stem and plural number wheels for controlling movements of said stem;
wherein said stem triggers said locking mechanism for controlling movements of said base end of said shackle; and
wherein said second locking means comprises: a body having a rotor received therein and a driving rod extended from said rotor, said rotor having a keyhole at a bottom end thereof for being engaged with a key, said driving rod is for controlling movements of said driving element.
